(19) United States
(12) Patent Application Publication
(10) Pub. No.: US 2013/0111721 A1
(43) Pub. Date: May 9, 2013

(54) HOLDER FOR AN ASSEMBLY OF A VEHICLE

(71) Applicant: ROBERT BOSCH GMBH, Stuttgart (DE)

(72) Inventors: Samir Mahfoudh, Buehl (DE); Roland Schmidt, Buehl (DE); Martin Bechtold, Buehl (DE)

(73) Assignee: ROBERT BOSCH GMBH, Stuttgart (DE)

(21) Appl. No.: 13/663,788

(22) Filed: Oct. 30, 2012

(30) Foreign Application Priority Data
Nov. 3, 2011 (DE) 10 2011 085 738.9

(51) Int. Cl. B23Q 3/00

(52) U.S. Cl. 29/281.1; 269/305

(57) ABSTRACT

A holder (1, 21) for an assembly (2) of a vehicle, in particular a pump, wherein the holder (1, 21) has a receiving region (4) which serves for receiving and holding the assembly (2), characterized in that recesses (5, 25) are provided in the holder (1, 21) for the purpose of connecting a holding means (3, 23) of the vehicle to the holder (1, 21), wherein recesses (5, 25) for more than one holding means (3, 23) are provided, wherein the recesses (5, 25) are arranged in a distributed manner in at least one portion of the holder (1, 21).

### BACKGROUND OF THE INVENTION

The invention relates to a holder for an assembly of a vehicle.

Holders for fastening an assembly, in particular a pump, to a vehicle are known.

### SUMMARY OF THE INVENTION

It is the object of the invention to provide an improved holder, in particular a holder with increased flexibility with regard to the mounting of the assembly in the vehicle.

The holder according to the invention has the advantage that a plurality of recesses is provided in the holder, such that multiple positions are possible for the mounting of the holder on a holding means of the vehicle. In this way, it is possible for the assembly to be fastened in various positions relative to the holding means of the vehicle. In this way, it is for example possible for different types of assemblies to be fastened by means of the same holder, or for the same assembly to be fastened in various positions relative to the holding means by means of the same holder. It is thus possible for the same holder to be used for different types of assemblies, in particular for different types of pumps. Furthermore, by means of the same holder, it is possible for an assembly to be mounted in different types of vehicles in different positions by means of the same holder. In this way, it is possible to limit the number of different types of holder, such that less logistical outlay is required.

In a further embodiment, the recesses are arranged so as to be distributed, in particular uniformly distributed, about an at least ring-segment-shaped portion of the holder. In this way, it is possible for the position of the assembly in the angular position to be fastened in different angular positions depending on the type of assembly or depending on the installation situation in the vehicle. In particular, in the case of the mounting of pumps which have a pump pressure connecting piece, the angular position of the pump pressure connecting piece may vary depending on the vehicle type. By means of the proposed holder, it is possible for the same holder to be used, pre-mounted on the assembly, for different vehicle types.

In a further embodiment, the receiving region is of sleeve-shaped form with a central axis, wherein the recesses are arranged substantially parallel to the central axis. The recesses are preferably arranged so as to be distributed over the entire sleeve-shaped form. A large number of different mounting positions are thus provided.

In a further embodiment, the recesses have a rectangular form, in particular a rounded rectangular form, in cross section perpendicular to a longitudinal axis of the recesses. As a result of the rectangular form of the recesses in cross section, it is possible for correspondingly formed holding means, which are of rectangular cross section, to be mounted on the holder. Good positively locking fastening of the holder to the holding means is thus permitted.

In a further embodiment, the recesses have a circular form, in particular an undulating circular form, in cross section perpendicular to a longitudinal axis of the recesses. In this way, a good positively locking connection of the holder to a cylindrical holding means is made possible.

In a further embodiment, the recesses extend from a bottom side of the holder to a top side of the holder. In this way, the available height of the holder is optimally utilized for positively locking connection to the holding means.

In a further embodiment, the holder has, on a top side and adjacent to the recesses, an elevated surface which serves for example to laterally overlap an end piece of the holding means. Since a mounted holding means projects beyond the recess, it is advantageous for the end of the holding means to be laterally covered by means of the elevated surface. In this way, the end of the holding means is protected against external action.

In a further embodiment, the elevated surface on a bottom side of the holder has, in the radial direction, a circular side surface which is provided preferably radially within the recesses. The radial side surface may serve as an abutment surface for an associated side surface of the holding means. A further improvement of the positively locking connection is thereby made possible.

In a further embodiment, the radial side surface of the elevated surface has, in cross section, an undulating contour which preferably is of S-shaped form and projects into regions between two recesses. Said radial side surface, too, may be used for the abutment of an associated side surface of the holding means. Furthermore, improved lateral coverage of a radial end piece of the holding means in cross section is made possible owing to the undulating contour. The undulating contour provides an enlarged side surface in relation to a radial contour. Increased lateral coverage of the end pieces of the holding means and/or an enlarged surface for positively locking abutment against a correspondingly formed holding means are thus provided.

In a further embodiment, the holder has a radial outer side which, in cross section, has an undulating, in particular S-shaped contour, wherein the recesses are arranged preferably in the region of radially outwardly projecting wave peaks. In this way, in particular in the case of a recess which is of circular cross section, a uniform thickness of the holder around the recesses is ensured. The positively locking connection, and in particular a uniform elastic coupling of the holder to a corresponding holding means, are thus ensured.

In a further embodiment, the receiving region has a radial inner side which faces toward the assembly to be received, wherein the radial inner side has further recesses which are preferably in the form of slots aligned parallel to a central axis of the holder. As a result of the provision of the further recesses, increased flexibility of the holder on the inner side is made possible, such that for example the mounting of the assembly and elastic hold of the assembly in the receiving region is improved.

In a further embodiment, the holder has, on a bottom side and radially within the recesses, an elevated surface with a radial side surface, wherein the radial side surface serves as a lateral guide surface for a correspondingly shaped side surface of the holding means. Improved positively locking fastening of the holder to the holding means is permitted in this way.

In a further embodiment, the elevated surfaces of the top side and of the bottom side are of identical form. Inexpensive production of the holder is permitted in this way. Furthermore, during the mounting of the holder, there are no different sides, such that incorrect mounting of the holder is not possible. Furthermore, the holding means can be inserted into the holder from both sides.

In a further embodiment, the receiving region is formed at least partially from an elastic material, in particular from an elastomer.

### BRIEF DESCRIPTION OF THE DRAWINGS

In the drawings:

FIG. 1 shows a schematic illustration of a pump with a holder and a holding means,

FIG. 2 shows a plan view of the holder,

FIG. 3 shows a cross section through the holder parallel to a central axis of the holder,

FIG. 4 shows a first embodiment of a holding means as per FIG. 1,

FIG. 5 shows a pump with a further embodiment of a holder and a further embodiment of a holding means in a perspective illustration,

FIG. 6 shows a plan view of the further holder,

FIG. 7 shows a section A-A through the further holder of FIG. 5,

FIG. 8 shows a second embodiment of a holding means as per FIG. 5, and

FIG. 9 shows a schematic partial cross section through the holder.

### DETAILED DESCRIPTION

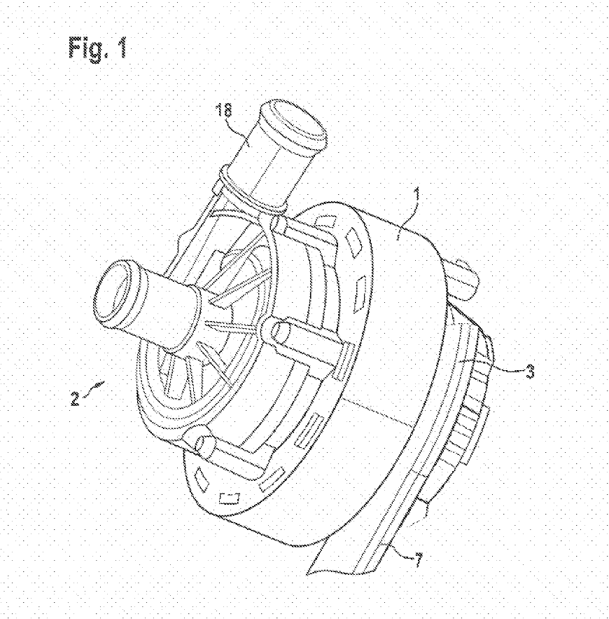

FIG. 1 shows a perspective illustration of a pump 2 which is fastened to a holder 1, wherein the holder 1 is in turn fastened to a holding means 3 which is connected to a vehicle. The pump 2 has a pump pressure connecting piece 18. The pump pressure connecting piece 18 is to be mounted in a certain angular position relative to the holding means 3 depending on a corresponding connecting point on the vehicle. The pump 2 is used as an example of an assembly of a vehicle. The use of the holder 1 is however not restricted to pumps 2 as assemblies, but rather may be used for any appliance which is mounted in a vehicle. The holder 1 has a receiving region 4 which serves for receiving and holding the assembly 2. In the illustrated exemplary embodiment, the receiving region is formed as an annular, preferably cylindrical opening. The receiving region 4 is matched to an outer contour of the assembly to be received, in this case of a cylindrical pump. Depending on the form of the assembly to be mounted, the receiving region of the holder 1 may also be of correspondingly different design.

In the exemplary embodiment illustrated, the holder 1 is of annular form. Depending on the selected embodiment, it is also possible for other forms of holder 1 to be used. In the holder 1 there are formed recesses 5 which are arranged in a distributed manner at least in one portion of the holder 1, wherein more recesses 5 than are required for a fastening of the holding means 3 are provided. In the exemplary embodiment illustrated, the recesses 5 are arranged so as to be distributed uniformly around the annular form of the holder 1. The holding means 3 is mounted on the holder 1 by means of two connecting elements 6. The two connecting elements 6 are inserted into two of the recesses 5. Owing to the multiplicity of recesses 5 provided, the holding means 3 can be arranged in various positions relative to the pump 2. Depending on the selected embodiment, it is also possible for more or fewer connecting elements 6 for connection to the holder 1 to be provided. The holding means 3 has a holding arm 7 from which the connecting elements 6 project laterally. The connecting elements 6 have, in end regions, broadened portions 8 which project out of the holder 1 and bear against a top side 9 of the holder 1. In the mounted state, the holder 1 is connected rotationally conjointly to the pump 2. This is realized for example on the basis of a preload of the holder 1. The holder 1 is produced for example from an elastomer, and the receiving region is flared as it is mounted onto the pump 2.

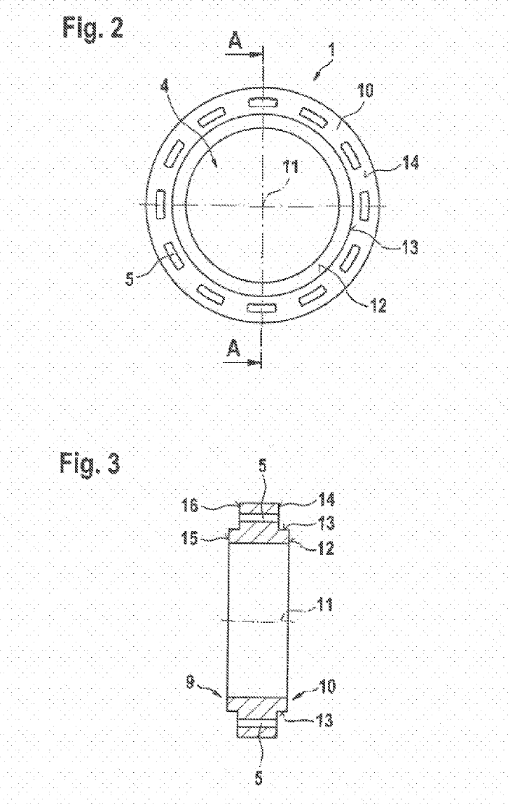

FIG. 2 shows the holder 1 in a view of the bottom side 10 which, in the mounted state, faces toward the holding means 3. The holder 1 has an annular form which surrounds the receiving region 4, which has the area of a circle. In the exemplary embodiment illustrated, the recesses 5 are arranged parallel to a central axis 11 of the holder 1. In cross section, the recesses 5 have a rectangular form which is preferably rounded in corner regions. The recesses 5 are preferably arranged along a circular line so as to be distributed uniformly about the central axis 11 of the holder 1. Depending on the selected embodiment, the recesses 5 may also be provided only in one portion of the holder 1, in particular one ring segment portion of the holder 1. Furthermore, the spacings between the recesses 5 may also vary. Furthermore, the holder 1 has an elevated first surface 12 on the bottom side 10. The first surface 12 is arranged radially within the recesses 5 and has a circular side contour 13. The first surface 12 projects beyond a second surface 14, wherein the recesses 5 are arranged in the second surface 14. Depending on the selected embodiment, it is also possible to dispense with the elevated first surface 12, such that the recesses 5 end in a uniform planar surface.

FIG. 3 shows a cross section through the holder 1, wherein the top side 9 also has an elevated further first surface 15. The recesses 5 are arranged in a further second surface 16 of the top side 9. Depending on the selected embodiment, the top side 9 may also be formed as a planar surface. It is preferable for the first surface 12 and the further first surface 15 and the second surface 15 and the further second surface 16 to be formed mirror-symmetrically with respect to a central plane. Therefore, in this embodiment, the holder 1 has mirror-symmetrical top and bottom sides 9, 10. Incorrect mounting of the holder 1 is thus not possible. The provision of the further elevated first surface 15 on the top side 9 offers the advantage that end pieces, that is to say the broadened portions 8 of the connecting elements 6, are laterally covered.

The design of the elevated first surface 12 with the radial side contour 13 offers the advantage that the radial side contour 13 abuts against a correspondingly formed second side contour 17 of the holding arm 7 of the holding means 3.

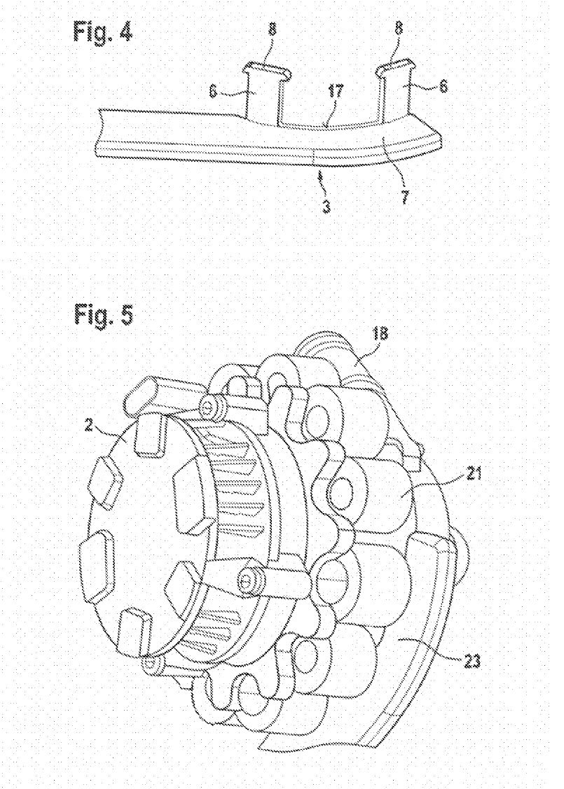

FIG. 4 shows the holding means 3 with the holding arm 7, wherein two connecting elements 6 project laterally out of the holding arm 7. Between the two connecting elements 6, a second side contour 17 is of circular segment form. The second side contour 17 is preferably arranged parallel to the longitudinal extent of the connecting elements 6. During the mounting of the holding means 3, the connecting elements 6 are pushed into two recesses 5, wherein furthermore the elevated first surface 12 is pushed laterally past the holding arm 7, such that the side contour 13 abuts against the further side contour 17 (see also FIG. 9). An improved positively locking connection of the holder 1 to the holding means 3 is provided in this way. The holding means 3 may for example be punched out of a metal sheet, and the connecting elements 6 bent up. Simple and inexpensive production is thus possible.

FIG. 5 shows a pump 2 with a second holder 21, wherein the second holder 21 is connected to a second holding means 23. The pump 2 is of identical design to the pump 2 in FIG. 1.

FIG. 5 shows the fastening of the second holding means 23 on the side of the pump pressure connecting piece 18 relative to the second holder 21.

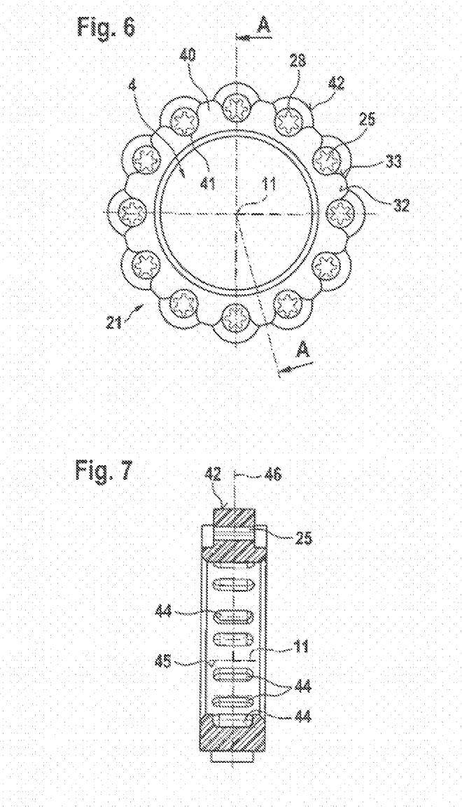

FIG. 6 shows a plan view of an underside 10 of the second holder 21. The second holder 21 has substantially an annular form which surrounds a circular receiving region 4. By contrast to the embodiment of the holder 1, the second holder 21 has further recesses 25 which have substantially a circular cross section in the cross section with respect to a longitudinal axis of the further recesses 25, wherein depending on the selected embodiment, the circular cross section in the edge contour 28 may be of undulating form as illustrated in FIG. 6. Owing to the undulating edge contour 28 of the second recesses 25, an improved positively locking connection with a correspondingly cylindrical second connecting element 26 is possible.

Furthermore, in the illustrated exemplary embodiment, the second holder 21 also has an elevated further first surface 32. The elevated further first surface 32 has a further radial side contour 33 which is likewise of undulating form, preferably S-shaped undulating form. Here, wave peaks 40 and wave troughs 41 alternate in the circumferential direction. The wave peaks 40 project in each case between two further recesses 25 and preferably extend as far as a radial side surface 42 of the second holder 21. Depending on the selected embodiment, the side surface 42 may have a circular or, as illustrated in the example, an undulating, in particular S-shaped, contour. The undulating side surface 42 is formed in such a way that wave peaks are arranged symmetrically in the radial direction with respect to second recesses 25, and wave troughs are arranged symmetrically in the radial direction between two second recesses 25. In this way, it is attained that a second recess 25 in the outer region is surrounded annularly by a uniform material thickness. In particular in the case of a second holding means 23 formed from an elastomer, this is advantageous for vibration behavior. Furthermore, a material saving is made possible in this way.

The radial further side contour 33 of the further first surface 32 of the underside offers the advantage that the further side contour 33 bears against a correspondingly formed third side contour 43 of the second holding means 23, and thus produces an improved positively locking connection between the second holding means 23 and the second holder 21. Furthermore, an elevated further first surface 32 on the top side offers the advantage that second portions 29, which are of circular, broadened form in cross section, of the second connecting elements 26 are covered. This can be seen in FIG. 5.

FIG. 7 shows a cross section A-A from FIG. 6, wherein the second holder 21 has a further first surface 32 with a further side contour 33 both on the top side and also on the bottom side. The top side and the bottom side of the second holder 21 are preferably of mirror-symmetrical form. Furthermore, FIG. 7 shows further recesses 44 which are formed in an inner side 45 of the second holder 21. The further recesses 44 are arranged in each case between two second recesses 25. The elasticity of the second holder 21 is increased in this way. The further recesses 44 have a rounded rectangular cuboidal form arranged in the longitudinal direction parallel to the central axis 11. Furthermore, the further recesses 44 are arranged center-symmetrically with respect to a central plane 46 of the second holder 21. The further recesses 44 have, in the longitudinal direction, a length smaller than the length of the second holder 21 in the longitudinal direction of the central axis 11. Depending on the selected embodiment, it is also possible for the further recesses 44 to be dispensed with, or for example for a further recess 44 to be provided only between every second pair of second recesses 25.

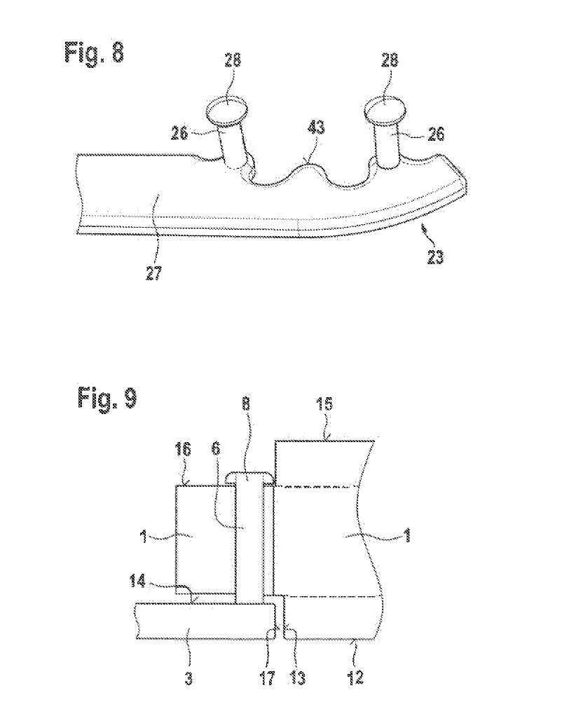

FIG. 8 shows the second holding means 23, which has a third side contour 43 which, in the mounted state, bears against the further side contour 33 and produces a positively locking connection. The third side contour 43 is for this purpose of undulating form, correspondingly to the further side contour 33. The second holding means 23 has a second holding arm 27 to which the second connecting elements 26 are fastened. The second connecting elements 26 have a circular cross section and, on the end, circular second broadened portions 28. The second broadened portions 28 also bear, in the mounted state, against the second holder 21, as illustrated in FIG. 5. The second connecting elements 26 are for example in the form of pins.

The pump 2 may for example be provided as a cooling circuit pump which, by means of the described holder, is fastened to the holding means of the vehicle so as to be damped with regard to vibrations. The holding means 3, 23 may be formed from sheet metal or plastic with metal or plastic pins. The connecting elements are held in the recesses 5 by means of an interference fit. The pump 2 is secured against rotation relative to the holder by means of an interference fit in the holder. Furthermore, the unused recesses 5, 25 have the advantage that increased damping of the elastomer is attained. A further decoupling of the assembly from vibrations of the vehicle is thus attained.

FIG. 9 shows, in a schematic illustration, a partial cross section through the arrangement of FIG. 1 in the region of the connecting element 6. It can be clearly seen here that the radial side contour 13 of the first surface 12 bears against the second side contour 17 of the holding element 3. It can also be clearly seen that the further first surface 15 projects beyond the end piece of the connecting element 6, that is to say the broadened portion 8, parallel to the central axis 11. The second holder 21 is formed, and connected in a positively locking manner to the second holding means 23, in an analogous manner.

As already stated, it is possible both on the top side and also on the bottom side for the elevated first surface 12 and the elevated further first surface 15 to be dispensed with. In said embodiment, the holder 1 then has a planar top side and a planar bottom side, as illustrated by dashed lines.

1. A holder (1, 21) for an assembly (2) of a vehicle, wherein the holder (1, 21) has a receiving region (4) which serves for receiving and holding the assembly (2), characterized in that recesses (5, 25) are provided in the holder (1, 21) for the purpose of connecting a holding means (3, 23) of the vehicle to the holder (1, 21), wherein recesses (5, 25) for more than one holding means (3, 23) are provided, wherein the recesses (5, 25) are arranged in a distributed manner in at least one portion of the holder (1, 21).

2. The holder according to claim 1, wherein the recesses (5, 25) are arranged so as to be distributed about an at least ring-segment-shaped portion of the holder (1, 21).

3. The holder according to claim 1, wherein the receiving region (4) is of cylindrical form with a central axis (11), wherein the recesses (5, 25) are arranged substantially parallel to the central axis (11).

4. The holder according to claim 1, wherein the recesses (5) have a rectangular form in cross section perpendicular to a longitudinal axis of the recesses.

5. The holder according to claim 1, wherein the recesses (25) have a circular form in cross section perpendicular to a longitudinal axis of the recesses.

6. The holder according to claim 1, wherein the holder has, on a top side and adjacent to the recesses (5, 25), an elevated surface (12, 15, 32) which serves to laterally overlap an end piece (8, 28) of the holding means (3, 23).

7. The holder according to claim 6, wherein the elevated surface (12, 15) has a circular side surface (13) which is arranged in a radial direction and which is provided within the recesses (5).

8. The holder according to claim 6, wherein the elevated surface (32) has a side surface (33) which is arranged in the radial direction and which, in cross section, has an undulating contour which projects into regions between two recesses (25).

9. The holder according to claim 1, wherein the holder has a radial outer side (42), wherein the outer side (42), in cross section, has an undulating contour.

10. The holder according to claim 1, wherein the receiving region (4) has a radial inner side (45) which faces toward the assembly (2) to be received, wherein the radial inner side (45) has further recesses (44).

11. The holder according to claim 1, wherein the holder has, on a bottom side (10) and radially within the recesses (5, 25), an elevated surface (12, 32) with a radial side surface (13, 33), wherein the radial side surface (13, 33) serves as a lateral guide surface for a side surface (17, 43) of the holding means (3, 23).

12. The holder according to claim 6, wherein elevated surfaces (12, 15, 32) of the top side (9) and of a bottom side (10) are of identical form.

13. The holder according to claim 1, wherein the holder is formed at least partially from an elastic material.

14. The holder according to claim 1, wherein the recesses (5, 25) are arranged so as to be uniformly distributed about an at least ring-segment-shaped portion of the holder (1, 21).

15. The holder according to claim 1, wherein the recesses (25) have an undulating circular form in cross section perpendicular to a longitudinal axis of the recesses.

16. The holder according to claim 6, wherein the elevated surface (12, 15) has a circular side surface (13) which is arranged in the radial direction and which is provided radially within the recesses (5).

17. The holder according to claim 6, wherein the elevated surface (32) has a side surface (33) which is arranged in the radial direction and which, in cross section, has an undulating contour which is of S-shaped form and projects into regions between two recesses (25).

18. The holder according to claim 1, wherein the holder has a radial outer side (42), wherein the outer side (42), in cross section, has an S-shaped contour, wherein the recesses (25) are arranged in the region of radially outwardly projecting wave peaks.

19. The holder according to claim 1, wherein the holder is formed at least partially from an elastomer.
